(19) United States
(12) Patent Application Publication
(10) Pub. No.: US 2011/0191853 A1
(43) Pub. Date: Aug. 4, 2011

(54) SECURITY TECHNIQUES FOR USE IN MALICIOUS ADVERTISEMENT MANAGEMENT

(75) Inventor: Faizal Atcha, Woodbridge, NJ (US)

(73) Assignee: Yahoo! Inc., Sunnyvale, CA (US)

(21) Appl. No.: 12/699,402

(22) Filed: Feb. 3, 2010

(51) Int. Cl. G06F 21/00; G06Q 30/00

(52) U.S. Cl. 726/25; 705/14.73

(57) ABSTRACT

The present invention provides methods and systems for use in malicious advertisement management. Methods and systems are provided in which, after an advertisement is determined not to present a security threat, whether initially or after removal any such threat, then a first modification is performed to code associated with the advertisement which may introduce a security coding. Further modification, which may breach the security coding, may indicate that the advertisement is more likely to present a security threat than if the further modification had not occurred.

### CROSS-REFERENCE TO RELATED APPLICATION

This application is related to application Ser. No. 12/535,514, filed on Aug. 4, 2009, entitled, “MALICIOUS ADVERTISEMENT MANAGEMENT”, which is hereby incorporated herein by reference in its entirety.

### BACKGROUND

Malicious online advertisements continue to present problems, including problems for advertising networks, such as Web portals including search engines and search engine providers, as well as for users who receive the advertisements. In a process often known as editorial, advertising networks, or other responsible or involved entities, often perform checks to try to ensure that advertisements are safe. These checks may include automated or human checks, or a combination thereof. The checks are often performed prior to the advertisements going “live”, or being available for serving to users. Designers of malicious advertisements, however, are motivated and skilled at creating malicious advertisements that are difficult to detect.

Additionally, factors such as sophisticated, constantly evolving, and rapidly changing technologies provide ongoing new opportunities for creative designers of malicious advertisements. This can make it very difficult to keep ahead of and detect malicious advertisements. As just one of many examples, malicious advertisements have cropped up that behave normally for a period of time, but are set to, or can be triggered to, change their behavior at a later time. Such advertisements may pass editorial in their initial form, but may essentially morph into something different and dangerous, or may change their behavior and behave maliciously, at a later time, which may be during active serving.

There is a need for security techniques for use in malicious advertisement management.

### SUMMARY

The present invention provides methods and systems for use in malicious advertisement management, including techniques for ensuring that advertisements are not malicious. In some embodiments, at an inactive time, an advertisement is tested to determine a set of information identifying a set of behavioral characteristics associated with the advertisement. After the advertisement is determined not to present a potential or actual security threat based at least in part on the set of information, whether or not after removal of any such threat, a first modification is performed to code associated with the advertisement. The first modification may introduce a security coding. Any further modification, which may breach the security coding, may indicate that the advertisement is more likely to present a security threat than if the further modification had not occurred. At an active time, the advertisement is assessed to determine whether a further modification of code associated with the advertisement appears to have occurred following the first modification. If it is determined that such further modification has occurred, then at least one action is taken reflecting a determination that the advertisement is more likely to present a potential or actual security threat than if it had been determined that the further modification had not occurred.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

Some embodiments of the invention provide methods and systems for use in malicious advertisement management, including ensuring that advertisements, such as advertisements serving in connection with an online advertising exchange, do not present a security threat, for example, when served to users.

Some embodiments of the invention can be used with, or combined with aspects of, previously incorporated by reference application Ser. No. 12/535,514, filed on Aug. 4, 2009, entitled, “MALICIOUS ADVERTISEMENT MANAGEMENT”. For example, some techniques described in application Ser. No. 12/535,514 include comparing behavioral characteristics of advertisements at a non-active time and at an active time or times, to determine whether there has been a change that may indicate that the advertisement may be malicious. Some embodiments of the present invention utilize techniques that are in some ways similar. However, potentially among other things, instead of comparing behavioral characteristics of an advertisement at different times to detect a change, some embodiments of the present invention utilize techniques that include use of a security coding.

For example, in some embodiments, either before or after an advertisement is determined not to be malicious or present a threat, a security coding is added to coding associated with the advertisement. In some embodiments, a security coding can indicate anything or any message with respect to maliciousness or non-maliciousness, threat or non-threat, level of threat, level or degree of maliciousness, a stage in maliciousness or threat assessment, a point in review for maliciousness or threat assessment, a condition with respect to maliciousness or threat, etc. Later, the advertisement may be sampled and checked to determine if the security coding has been breached, such as, for example, by being altered in any way. Breach of the security coding may indicate that code associated with the advertisement has been altered, which may suggest an increased risk that the advertisement's behavioral characteristics have changed and present a threat. As such, in some embodiments, if the security coding is breached, action may be taken consistent with an increased security risk being presented by the advertisement. For instance, if the security code is breached, behavioral characteristics associated with the advertisement may be determined to ensure that the advertisement has not become insecure or a threat. In some embodiments, checking of the security code provides an indication of whether the advertisement has been altered, or whether its behavioral characteristics have been altered and potentially made dangerous, without actually checking the behavioral characteristics associated with the advertisement, at least initially.

Some embodiments of the invention include action taken during or at the conclusion of an editorial process. For example, once an advertisement has passed an editorial process, including having been found to be non-threatening, a security coding may be introduced or added to code associated with the advertisement. Later, the advertisement can be assessed to determine whether the security coding has been breached, which may suggest that the advertisement may be more likely to have been altered from its safe form and may present a security threat.

In some embodiments, if an advertisement is determined to have threatening characteristics, such characteristics may be removed or neutralized to ensure that the advertisement does not present a security risk, prior to insertion of a security code. For instance, some advertisements may be coded to cause them to, in addition to presenting a creative or graphical advertisement, access and potentially cause to be downloaded onto a user computer, perhaps transparently to a user, onto the user's computer, an insecure or malicious resource. This could include introduction of a virus, worm, Trojan horse, malware, etc. Such an insecure resource may include any resource outside the control or access of an entity associated with facilitating the advertising process or serving of the advertisement, or an entity associated with operation or facilitation of an associated advertising exchange.

In some embodiments, an advertisement is checked to ensure, for instance, that it will not cause access to, or downloading of, such a potentially dangerous resource. As a further example, the advertisement may be checked to ensure that it will not read, execute, delete, modify, add anything, etc. to a user computer, or do so in an appropriate way. This can involve checking code of or otherwise associated with the advertisement.

In various embodiments, the security coding can take many different forms. In some embodiments, the security coding can act as an authentication coding or form of digital watermark, signature, certification, or other form of security, authenticity or non-alteration check. In other embodiments, the security coding can alternatively or additionally provide a message, perhaps after being decoded. The message can be something simple, such as an indication of when the advertisement passed a security check, or particulars in that regard, or could be something more complex.

In some embodiments, the security coding can take a which is difficult or impossible to detect, or may be invisible, from a third party or user perspective. For instance, in some embodiments, a bit or set of bits associated with one or more pixels of a graphical element of an advertisement may be modified. This may fuzz, or barely visibly or invisibly alter the code associated with, or the appearance of, the associated graphic. Even if not visibly detectable, however, the alteration may be detectable upon checking the code associated with the advertisement. In some embodiments, a series or set of such alterations may be used as a form of checksum. Such alterations may be detectable upon assessment of the advertisement or associated code, and may indicate that the advertisement has been altered and may present an increased security threat.

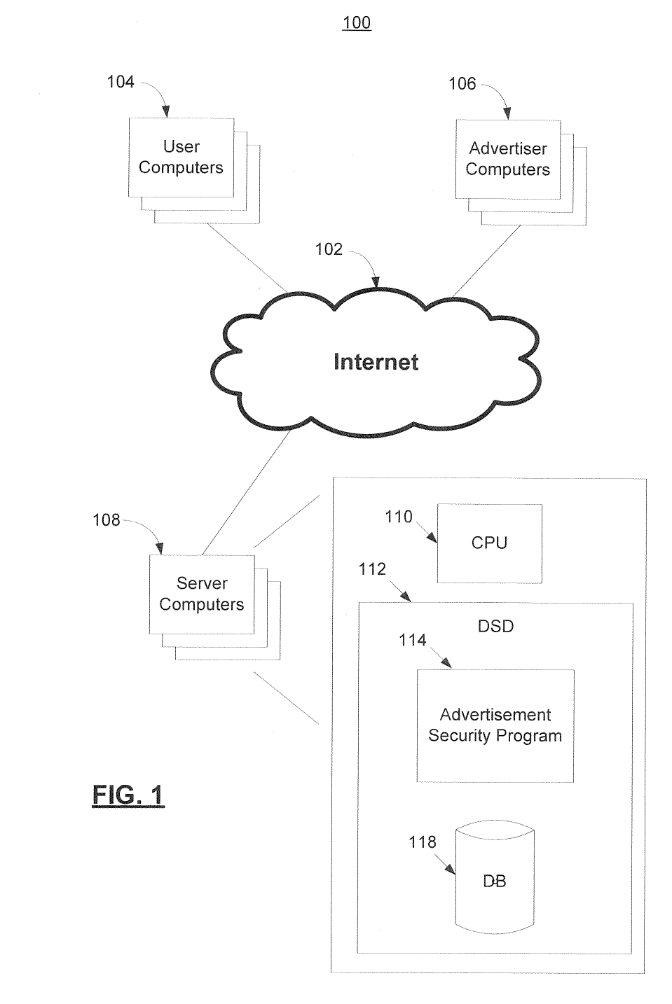

FIG. 1 is a distributed computer system 100 according to one embodiment of the invention. The system 100 includes user computers 104, advertiser computers 106 and server computers 108, all coupled or coupleable to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Advertisement Security Program 114.

The Program 114 is intended to broadly include all programming, applications, algorithms, software and other tools necessary to implement or facilitate methods and systems according to embodiments of the invention. The elements of the Program 114 may exist on a single server computer or be distributed among multiple computers or devices.

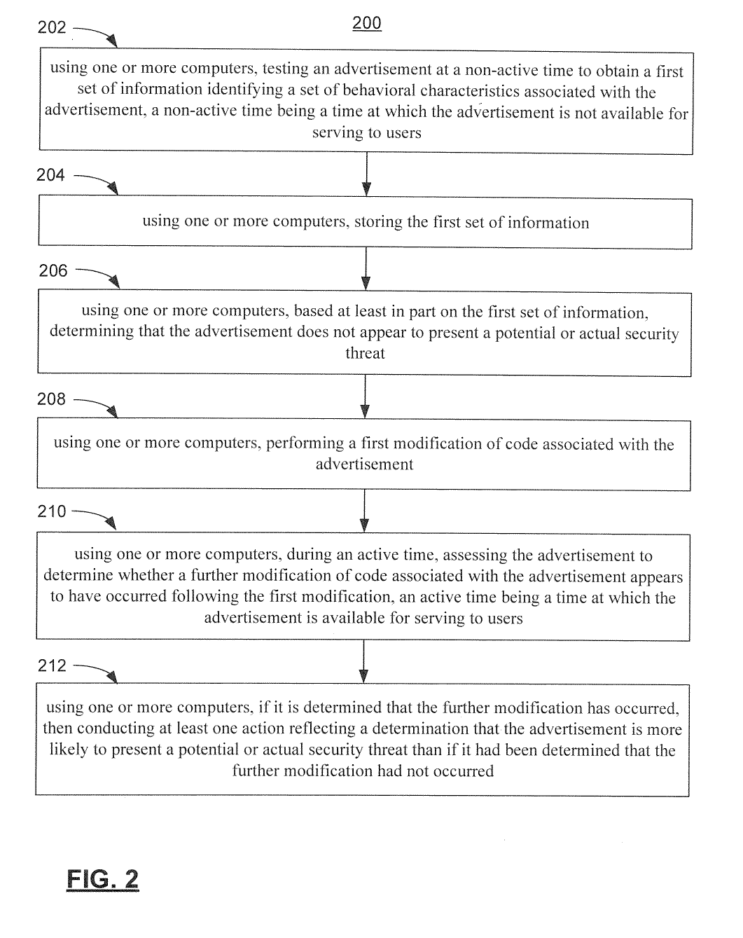

FIG. 2 is a flow diagram illustrating a method 200 according to one embodiment of the invention. At step 202, using one or more computers, an advertisement is tested at a non-active time to obtain a first set of information identifying a set of behavioral characteristics associated with the advertisement, a non-active time being a time at which the advertisement is not available for serving to users.

At step 204, using one or more computers, the first set of information is stored.

At step 206, using one or more computers, based at least in part on the first set of information, it is determined that the advertisement does not appear to present a potential or actual security threat.

At step 208, using one or more computers, a first modification of code associated with the advertisement is performed.

At step 210, using one or more computers, during an active time, the advertisement is assessed to determine whether a further modification of code associated with the advertisement appears to have occurred following the first modification, an active time being a time at which the advertisement is available for serving to users.

At step 212, using one or more computers, if it is determined that the further modification has occurred, then at least one action is conducted reflecting a determination that the advertisement is more likely to present a potential or actual security threat than if it had been determined that the further modification had not occurred.

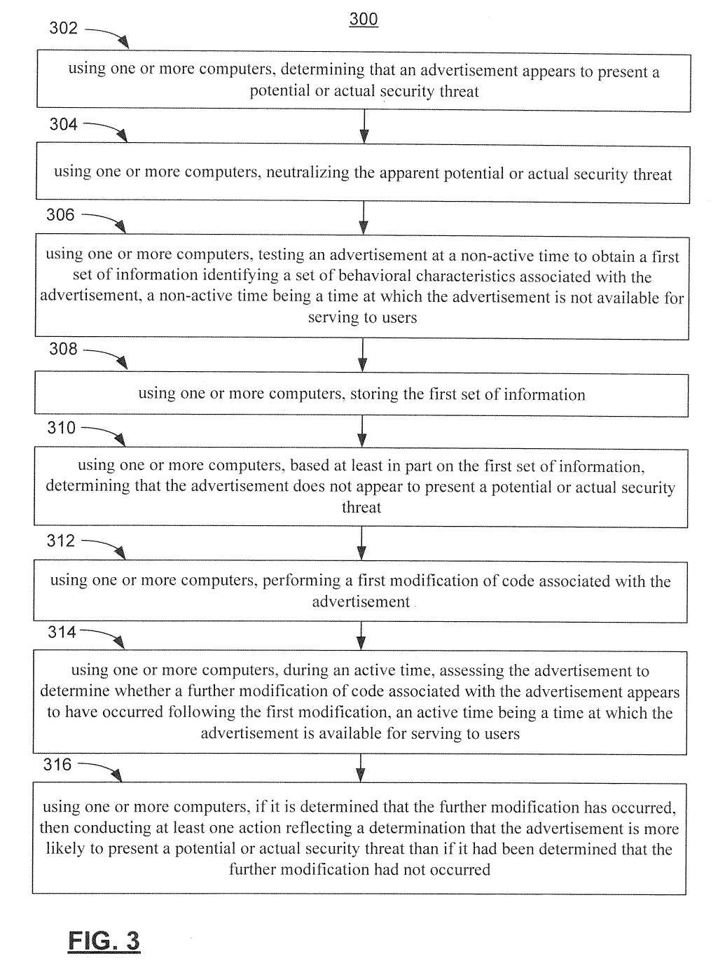

FIG. 3 is a flow diagram illustrating a method 300 according to one embodiment of the invention.

At step 302, using one or more computers, it is determined that an advertisement appears to present a potential or actual security threat.

At step 304, using one or more computers, the apparent potential or actual security threat is neutralized, such as by modifying code associated with the advertisement.

Step 306 to 316 are similar to steps 202 to 212 as depicted in FIG. 2, respectively.

The embodiment depicted in FIG. 3 can, for example, reflect a situation in which an advertisement is found, perhaps during an offline security check or editorial process, to present a potential or actual security threat. In such an instance, the threatening aspect or aspects of the advertisement may be neutralized prior to a determination that the advertisement does not present a potential or actual security threat, as in step 310. It is to be noted that, in some embodiments, steps 306 may be different or omitted.

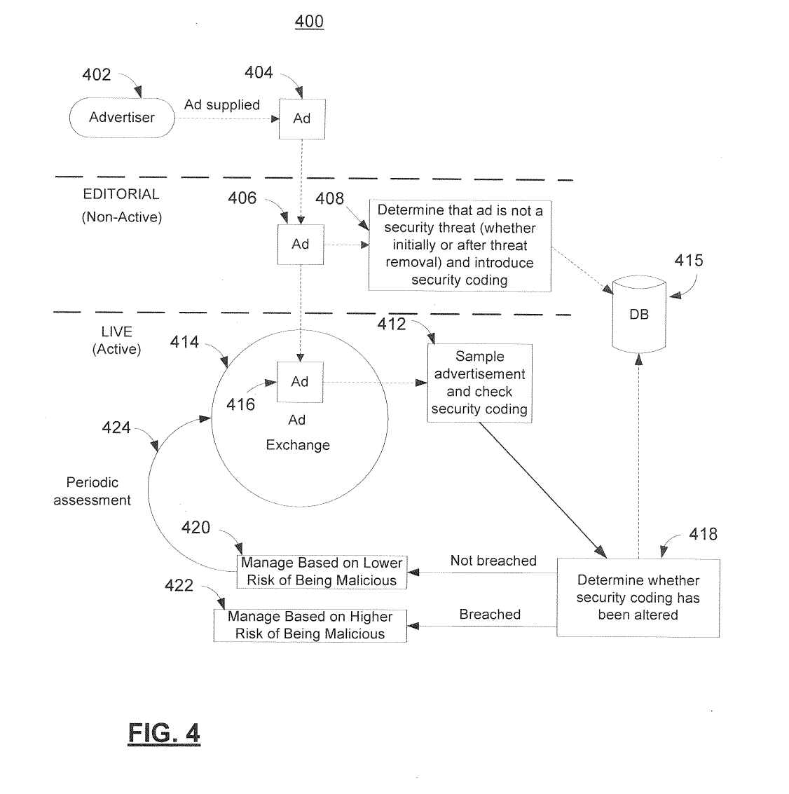

FIG. 4 is a block diagram 400 illustrating one embodiment of the invention. As depicted, an advertiser 402, or a proxy of an advertiser, submits an advertisement 404, which makes its way into an editorial process, as depicted by the advertisement 406, before going active or live (being made available for serving to users).

At block 408, as part of the editorial process, it is determined that the advertisement does not present a potential or actual security threat, and information reflecting this determination may be stored in a database 415. In so embodiments, if an advertisement is determined to present a threat, the threat is neutralize before it is determined that the advertisement does not present a threat. As just one example, if an advertisement is determined to present a threat because it is coded to access an insecure resource, code associated with the advertisement may be modified to remove its ability to do this.

Also at block 408, once it is determined that the advertisement is not a threat, security coding is introduced into code associated with the advertisement. Later, if the security coding is breached, which may include any alteration of the code associated with the advertisement, this can indicate that the advertisement has been modified following insertion of the coding, which may indicate that the advertisement is more likely to be malicious or present a threat than if the security coding had not been breached.

In some embodiments, at different times after the advertisement goes active or live (made available for serving to users), the advertisement may be sampled and assessed. As depicted, at block 412, the advertisement 416 is sampled from an online advertising exchange 414. The advertisement 416 is assessed, also at block 412, and its security coding is checked.

At block 418, based at least in part on the assessment, it is determined whether the security coding has been breached, and information relating to this determination is stored in the database 415. If the security coding is determined to have been breached, at block 422, the advertisement is managed based on presenting a higher security risk or risk of being malicious, whereas, if the security coding is determined not to have been breached, then at step 420, the advertisement is managed based on presenting a lower security risk or risk of being malicious. For example, management based on higher risk can include causing the ad to be taken offline or quarantined, or checking its behavioral characteristics to determine whether it presents a security threat in its current form. As indicated by arrow 424, in some embodiments, once determined to present a lower or no risk, an advertisement may be allowed to enter, re-enter, or continue to remain on the exchange 414 in active mode, and periodic or otherwise repeated assessment or checks may continue to be made.

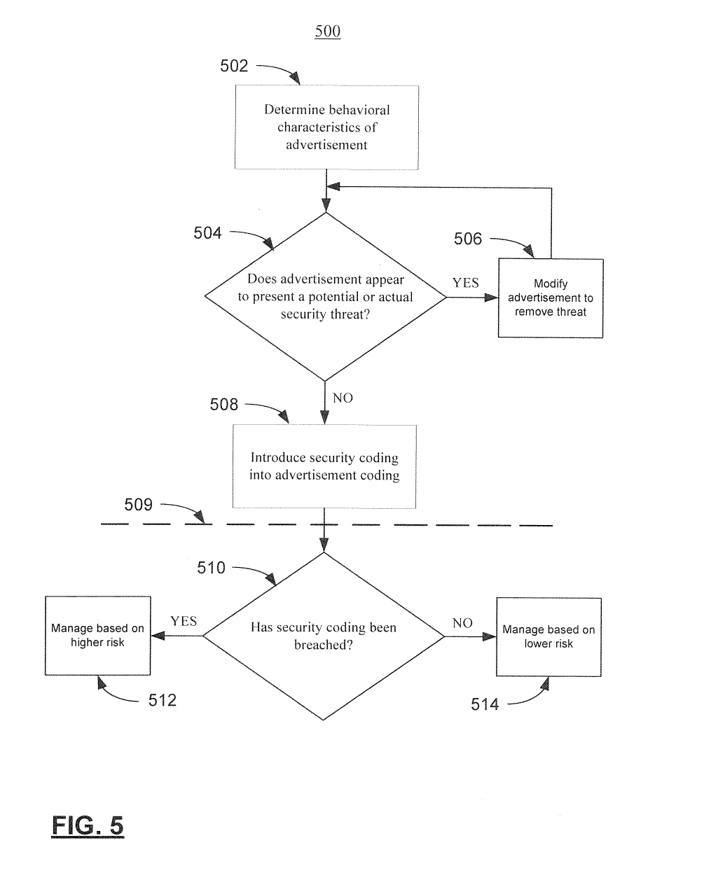

FIG. 5 is a flow diagram of a method 500 according to one embodiment of the invention. At step 502, a set of behavioral characteristics of an advertisement are determined.

At step 504, it is queried whether the advertisement appears to present a potential or actual security threat.

If so, at step 506, the advertisement is modified so as to remove or neutralize the threat, and then the method 500 returns to step 504.

If not, at step 508, security coding is introduced into advertisement coding.

Broken line 509 represents the advertisement going live.

At step 510, at a time during which the advertisement is live, it is determined whether the security coding has been breached. This can include sampling and assessing the advertisement and its code.

If so, at step 512, the advertisement is managed based on presenting a higher risk.

If not, at step 514, the advertisement is managed based on presenting a lower risk.

It is to be understood that the method 500 depicted in FIG. 5 is simplified and merely for illustrative purposes.

The foregoing description is intended merely to be illustrative, and other embodiments are contemplated within the spirit of the invention.

1. A method comprising:
using one or more computers, testing an advertisement at a non-active time to obtain a first set of information identifying a set of behavioral characteristics associated with the advertisement, a non-active time being a time at which the advertisement is not available for serving to users;
using one or more computers, storing the first set of information;
using one or more computers, based at least in part on the first set of information, determining that the advertisement does not appear to present a potential or actual security threat;
using one or more computers, performing a first modification of code associated with the advertisement;
using one or more computers, during an active time, assessing the advertisement to determine whether a further modification of code associated with the advertisement appears to have occurred following the first modification, an active time being a time at which the advertisement is available for serving to users; and
using one or more computers, if it is determined that the further modification has occurred, then conducting at least one action reflecting a determination that the advertisement is more likely to present a potential or actual security threat than if it had been determined that the further modification had not occurred.

2. The method of claim 1, comprising determining if a further modification has occurred by determining whether code modified by the first modification has been altered after the first modification.

3. The method of claim 1, comprising, prior to determining that the advertisement does not appear to present a potential or actual security threat:
determining that the advertisement appears to present a potential or actual security threat; and
modifying code associated with the advertisement to remove the potential or actual security threat.

4. The method of claim 1, wherein performing a first modification of code comprises fuzzing code associated with the advertisement, and wherein detected alteration of fuzzed code indicates a further modification of code associated with the advertisement.

5. The method of claim 1, wherein performing a first modification of code comprises modifying code associated with at least one pixel.

6. The method of claim 1, wherein performing a first modification of code comprises modifying code such that the advertisement as presented is not visibly modified.

7. The method of claim 1, wherein performing a first modification of code comprises introducing a checksum or digital watermark.

8. The method of claim 1, wherein performing a first modification of code comprises introducing a digital watermark.

9. The method of claim 1, wherein performing a first modification of code comprises introducing a coded message.

10. The method of claim 1, wherein determining that a further modification has occurred comprises determining that a security coding, resulting from the first modification, has been breached.

11. The method of claim 1, wherein taking at least one action comprises at least temporarily removing the advertisement from being available for serving to users.

12. The method of claim 1, wherein taking least one action comprises testing behavioral characteristics associated with the advertisement to determine if a change in the behavioral characteristics has occurred since the first set of information was obtained.

13. The method of claim 1, comprising, during an active period, repeatedly or periodically over time, assessing the advertisement to determine whether a further modification of code associated with the advertisement appears to have occurred following the first modification and at an active time.

14. The method of claim 1, wherein presenting a potential or actual security threat comprises presenting a risk of being malicious.

15. The method of claim 1, wherein presenting a potential or actual security threat comprises presenting a risk of introducing a dangerous resource onto a user computer.

16. The method of claim 1, wherein presenting a potential or actual security threat comprises presenting a risk of deleting or modifying a resource or code stored on a user computer.

17. A system comprising:
one or more server computers connected to a network; and
one or more databases connected to the one or more server computers;
wherein the one or more server computers are for:
testing an advertisement at a non-active time to obtain a first set of information identifying a set of behavioral characteristics associated with the advertisement, a non-active time being a time at which the advertisement is not available for serving to users;
storing the first set of information in at least one of the one or more databases;
based at least in part on the first set of information, determining that the advertisement does not appear to present a potential or actual security threat;
performing a first modification of code associated with the advertisement;
during an active time, assessing the advertisement to determine whether a further modification of code associated with the advertisement appears to have occurred following the first modification, an active time being a time at which the advertisement is available for serving to users; and
if it is determined that the further modification has occurred, then conducting at least one action reflecting a determination that the advertisement is more likely to present a potential or actual security threat than if it had been determined that the further modification had not occurred.

18. The system of claim 17, comprising, if it is determined that the further modification has occurred, removing the advertisement from being available for serving to users for at least a period of time.

19. The system of claim 17, comprising, prior to determining that the advertisement does not appear to present a potential or actual security threat:
determining that the advertisement appears to present a potential or actual security threat; and
modifying code associated with the advertisement to remove the potential or actual security threat.

20. A computer readable medium or media containing instructions for executing a method, the method comprising:
using one or more computers, determining that an advertisement appears to present a potential or actual security threat;
using one or more computers, neutralizing the apparent potential or actual security threat;
using one or more computers, testing an advertisement at a non-active time to obtain a first set of information identifying a set of behavioral characteristics associated with the advertisement, a non-active time being a time at which the advertisement is not available for serving to users;
using one or more computers, storing the first set of information;
using one or more computers, based at least in part on the first set of information, determining that the advertisement does not appear to present a potential or actual security threat;
using one or more computers, performing a first modification of code associated with the advertisement;
using one or more computers, during an active time, assessing the advertisement to determine whether a further modification of code associated with the advertisement appears to have occurred following the first modification, an active time being a time at which the advertisement is available for serving to users; and
using one or more computers, if it is determined that the further modification has occurred, then conducting at least one action reflecting a determination that the advertisement is more likely to present a potential or actual security threat than if it had been determined that the further modification had not occurred.
